(19) United States
(12) Patent Application Publication
(10) Pub. No.: US 2024/0291010 A1
(43) Pub. Date: Aug. 29, 2024

(54) Nafion Self-Bonding for Cost-Effective Rapid Assembly of a Thin Flexible Fuel Cell by a Template-Based Thermal Sealing Process

(71) Applicant: The Trustees of The Stevens Institute of Technology, Hoboken, NJ (US)

(72) Inventors: Seyed Reza Mahmoodi, Berkeley, CA (US); Ronald Besser, New Providence, NJ (US); Matt Mayer, Binghamton, NY (US); Pei-Kang Sun, Hoboken, NJ (US)

(21) Appl. No.: 18/559,960

(22) PCT Filed: May 13, 2022
(86) PCT No.: PCT/US2022/029324

§ 371 Date: Nov. 9, 2023

Related U.S. Application Data
(60) Provisional application No. 63/188,422, filed on May 13, 2021.
(60) Provisional application No. 63/188,425, filed on May 13, 2021.

(51) Int. Cl. H01M 8/1004

(52) U.S. Cl. CPC H01M 8/1004; H01M 2300/0082

(57) ABSTRACT

Methods useful for the manufacturing of microfluidic cells useful in electronics and other applications are disclosed. In this technique, an air cushioned pressure supplies the force to bond a membrane, which can be made from one or more of the sulfonated tetrafluoroethylene polymers commercially known as Nafion™ (i.e., proton exchange membranes) or from other thermoplastic substrates. A substrate is compressed and templated while it is simultaneously sealed inside the cell. The resultant microcells are strongly sealed while being patterned according to their application.

### CROSS-REFERENCE TO RELATED APPLICATION

This application claims priority to U.S. Provisional Patent Application Ser. No. 63/188,425 filed May 13, 2021 and U.S. Provisional Patent Application Ser. No. 63/188,422 filed May 13, 2021, the entireties of which are incorporated herein by reference when and where permissible.

### STATEMENT REGARDING FEDERALLY SPONSORED RESEARCH

This invention was made with government support under Grant No. ECCS1040007 awarded by the National Science Foundation of the United States of America. The U.S. government therefore has certain rights in the invention.

### FIELD OF THE INVENTION

The present invention relates to compact power sources and electronic structures, and more specifically, to microfluidic fuel cells.

### BACKGROUND OF THE INVENTION

Thermoplastics are emerging as a substitute for conventional materials in microfluidic devices with commercial or clinical applications, owing to their higher versatility, low cost, industrial scalability and ease of handling and packaging.

Some specific limitations of conventional silicon or glass-based processing techniques have prompted researchers to explore alternative materials. Initially, PDMS was viewed as a logical base material. However, in recent years, a shift towards the employment of thermoplastics for microfluidic systems due to material property issues associated with PDMS (e.g., surface treatment instability, bulk absorption of small molecules and evaporation through the device) has been seen.

A significant drawback of most microfluidic processing techniques is that with standard technology, only one substrate, generally the bottom substrate, can contain active elements. As a result, the bottom substrate is normally considered to be the support with high enough thickness to accommodate the internal elements.

A combination of substrate thickness reduction with symmetric configuration of fluidic elements between the substrates is desirable by many microfluidic applications in view of device miniaturization, performance enhancement, and lowering cost. Additionally, the development of inexpensive bonding techniques is particularly important for applications in microelectromechanical systems (MEMS) packaging and flexible devices.

### SUMMARY OF THE INVENTION

The methods of the present invention improve upon the standard plate-to-plate, roll-to-roll and roll-to-plate lamination procedures for rapid and inexpensive assembly of microfluidic devices. The technique described herein enables the creation of templated structures within polymer-based devices. In this technique, an air cushioned pressure supplies the force to bond a membrane, which can be made from one or more of the sulfonated tetrafluoroethylene polymers commercially known as Nafion™ (i.e., proton exchange membranes) or from other thermoplastic substrates, and to template a structure within the substrate simultaneously. Consequently, the uniform distribution of stress over the bonding components accommodates relative rotations, surface irregularities and thickness variations along the bonding interface or even on the backside of the polymer substrates. In this technique, the conformable applied pressure controls the stress concentration on the bonding materials and inhibits substrate thinning or collapse. This capacity not only allows for the lamination of thin polymer substrates without any adhesives but also compensates for thickness dissimilarities when sealing a template between the substrates.

This fabrication process can be used separately or in combination with other techniques for the construction and packaging of different types of devices. In particular, the template-based thermal sealing of the present invention can facilitate the development of cost-effective microfluidic technologies. When using this technique for one-step production of thin flexible fuel cells (TFFCs), the fuel cell's gas diffusion electrodes (GDEs) are used as a porous template to form the anode microchannel, and two sheets of ion-exchange membrane are used for the base substrates. The ion-exchange membranes can be used with or without using adhesives to thermally seal the air-breathing fuel cell stack (i.e., the double-sided fuel cell).

The process flow would begin with the creation of the bonding assembly by sandwiching the template GDEs between Nafion™ films, followed by a thermal sealing step of the whole assembly. Cathode electrodes can be pressed onto the outer sides of the active area simultaneously or during a separate compression step. Then, if necessary, any templates used can be removed from the inner or outer layers of the device.

The present fabrication methodology is ideal for the mask-less assembly of flexible, lightweight, ultra-thin polymer-based devices. The inventive method is simpler than conventional methods of microfabrication based on complex photolithography and additive/subtractive material processes. Overall, the method is also more cost-effective than conventional methods of microfabrication. Furthermore, the thermal sealing technique can potentially be combined with conventional microfluidic assembly methods to lower the cost, reduce the size or improve the device performance.

The template-based thermal sealing method offers a simple, one-step, integrated construction approach for flexible microfluidic, microchemical, and micro electrochemical devices in which the package is integral with the functional parts of the device. As an example, the method of the present invention can be used for the assembly of energy sources with very high specific energy densities, such as microfluidic fuel cells to compete directly with battery technology as a power source for portable, wearable and flexible electronics and autonomous systems. Depending on the template used in the process, a variety of applications might be invoked. These applications can include filtration devices, electrolyzers, and microchemical systems such as chromatography, reformers and different types of thin and flexible sensors. Specific applications can also be seen in the area of autonomous and portable devices where high mass and volume specific energy density is increasingly becoming paramount. Yet further applications may lie in biomedical and healthcare monitoring devices, owing to the ability of the inventive technique to make flexible microfluidic platforms.

In another embodiment, given the flat configuration of the thin flexible fuel cell and the use of polymer-based microfabrication techniques for its construction, the thin flexible fuel cell can be readily integrated with other electronics with flat architectures which are commonly used in portable electronic devices. In a further embodiment, the fuel cell of the present invention can be used for packaging electronics with flat and flexible architectures commonly used in portable electronic devices. In yet another embodiment, the method of the present invention can be used to produce thin and flexible microfluidics that are especially suitable for a variety of biomedical applications and biosensors.

Micro fuel cells (MFC or μFC), such as the ones fabricated as a part of the present invention, can address energy challenges of niche applications where longer life span or lower life cycle cost than batteries are demanded. Such portable applications include but are not limited to electronic chargers, auxiliary power units and air/under-water vehicle applications. In the integrated microsystems or microfluidics sector (i.e., those that combine sensing function with an interface or computational capability in a single chip or module format), manufacturers are interested in longer power duration, lighter weight, and smaller size than batteries afford. In light of its potential for producing high energy density flexible fuel cells, the inventive device and method can be commercialized as a longer lasting and fast recharging alternative power source, to provide a great range of power in a variety of uses.

The thin, flexible fuel cell design can be applied for making various types of fuel cells or flow cells that can use ambient air (either forced flow or natural flow) as the oxidizer and also use thin polymer membrane electrolytes, including but not limited to hydrogen fuel cells, direct methanol fuel cells and air-breathing flow batteries.

In one embodiment of the present invention, a method for making microfluidic devices involves the process of pressing one or more substrates onto a template while simultaneously laminating one or more of the substrates. The substrates can be any of an array of thermoplastic substrates, polymethylmethacrylates, and/or sulfonated tetrafluoroethylene polymers. In other embodiments, cathode electrode patterns may also be applied to the substrate.

In further embodiments, the template may be interposed at a bonding interface for one or more of the substrates. The template may also include one or more gas diffusion electrodes and/or be porous. The template may also have a pair of opposed sides, wherein the pressing step applies the substrates to both sides of the template. The opposed sides may be symmetrical or asymmetrical.

In one embodiment, both the pressing and the laminating can be done via gas-assisted thermal bonding. In further embodiments, air-cushioned pressure, nanoprint lithography, or non-gas carrying rigid plates may be utilized for the pressing/laminating. In the first case, an inert gas can be used. In other embodiments, a fluorosilicone rubber film can be employed at the interface of the sample and the pressing system for more thorough distribution of pressure over irregular sample surfaces during the lamination process.

In certain embodiments, the template may be removed after the microfluidic device is sealed (i.e., laminated). This can be done via dissolution of the template, or removal of the template with the application of mechanical force onto the template.

In yet another embodiment, an aluminum or other metallic layer may be interposed between multiple laminated substrates with or without the use of a template during the pressing/sealing.

### BRIEF DESCRIPTION OF THE FIGURE

For a more complete understanding of the present invention, reference is made to the following detailed description of various representative embodiments considered in conjunction with the accompanying drawings, in which:

FIG. 1 is a schematic diagram illustrating a simultaneous sealing and microstructuring step in accordance with an embodiment of the present invention;

FIG. 2 is a schematic diagram illustrating a template-free thermal sealing process;

FIG. 3 is a schematic diagram depicting a conventional fuel cell;

FIG. 4 is a photographic depiction of a fuel cell equivalent to that shown in FIG. 3;

FIG. 5 is a schematic diagram showing an exploded view of a fuel cell made according to methods of the present invention;

FIG. 6 is a photograph depicting the fuel cell of FIG. 5;

FIG. 7 is a schematic diagram showing a top perspective view of the fuel cell of FIGS. 5 and 6;

FIG. 8A is a graph showing test results pertaining to Nafion™ substrates bonded in accordance with the methods of the present invention;

FIG. 8B is a series of photographs of the fuel cells associated with the data of FIG. 8A;

FIG. 9 is a scanning electron microscopy image showing the surface of a Nafion™ substrate that has been directly bonded to another Nafion™ substrate by conventional methods;

FIG. 10 is a scanning electron microscopy image showing the surface of a Nafion™ substrate that has been bonded to another Nafion™ substrate via a sheet of interposed aluminum, in accordance with an embodiment of the present invention.

FIGS. 11A and 11B are schematic diagrams showing the assembly of fuel cells in accordance with an embodiment of the present invention;

FIG. 12A is a schematic illustration of polymethylmethacrylate films rolled around a tubular template, pressed into two different sealing configurations;

FIG. 12B is a schematic illustration of a hollow PVC tube;

FIG. 13 is a photograph of patterned SU-8, an epoxy-based photoresist, on a Si substrate sealed between two PMMA films by GATB at 170° C. and 250 psi;

FIG. 14 is a series of images of template-based GATB assembly of a microfluidic device, showing a microfluidic device filled with dyed water (14A), a stereo-microscope image of the device (14B), a SEM cross section of a porous microchannel sealed by GATB at 170° C. and 250 psi (14C), and a diamond shape cut of carbon paper (14D) used as a porous template of the fluidic channel that remains in place after fabrication, the diameter of the outlet microchannel being 0.5 mm in FIG. 14A, and 0.2 mm in FIG. 14D;

FIG. 15 is a schematic diagram illustrating a test setup used to characterize a micro fuel cell based on Nafion (FIG. 15A) and Mylar (FIG. 15B);

FIG. 16A is a photograph of an outlet microchannel produced from de-molding of a wire template material;

FIG. 16B is a photograph of a porous anode microchannel before the pressing of cathode electrodes;

FIG. 17 is a power density plot of a micro fuel cell stack in dead-ended operation;

FIG. 18 is a Tafel plot of a micro fuel cell at two different hydrogen pressures;

FIG. 19 is a chart characterizing IR-free performances of a micro fuel cell at different flow rates;

FIG. 20 is a fuel utilization plot of a micro fuel cell at different flow rates;

FIG. 21A is a chart illustrating the effect of hydrogen pre-heating on a micro fuel cell;

FIG. 21B is a chart illustrating resistance change as a function of current density for a micro fuel cell at three different pre-heating temperatures; and

FIG. 22 is a dynamic electrochemical impedance spectroscopy plot (EIS) obtained at three different voltages for a micro fuel cell.

### DETAILED DESCRIPTION OF VARIOUS EMBODIMENTS

Embodiments will now be discussed in more detail referring to the drawings that accompany the present application. In the accompanying drawings, various embodiments are illustrated. It is to be understood, however, that these embodiments are merely illustrative of the invention, which can be embodied in various forms. In addition, the specific features of the illustrated embodiments are intended to be illustrative, and not restrictive. Further, the figure is not necessarily to scale, and some features may be exaggerated to show details of particular components with the understanding that sizes, materials and similar details shown in the figure are intended to be illustrative and not restrictive. Therefore, specific structural and functional details illustrated in the accompanying drawings are not to be interpreted as limiting, but merely as a representative basis for teaching one skilled in the art how to make and use the embodiments disclosed and illustrated herein.

Subject matter will also be described in the following text with reference to the accompanying drawings. The subject matter described hereinafter may, however, be embodied in a variety of different forms and, therefore, such subject matter should not be construed as being limited to any of the exemplary embodiments described herein. Among other things, for example, the disclosed subject matter may be embodied in the form of methods, devices, components, systems and/or combinations thereof. The following detailed description is, therefore, not intended to be taken in a limiting sense.

Throughout the Specification, terms may have nuanced meanings suggested or implied in context beyond an explicitly stated meaning. Likewise, the phrase “in one embodiment” as used herein does not necessarily refer to the same embodiment and the phrases “in another embodiment” and “other embodiments” as used herein do not necessarily refer to a different embodiment. It is intended, for example, that the disclosed subject matter includes combinations of the exemplary embodiments, in whole or in part.

In general, terminology may be understood, at least in part, from usage in context. For example, terms, such as “and,” “or,” or “and/or,” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

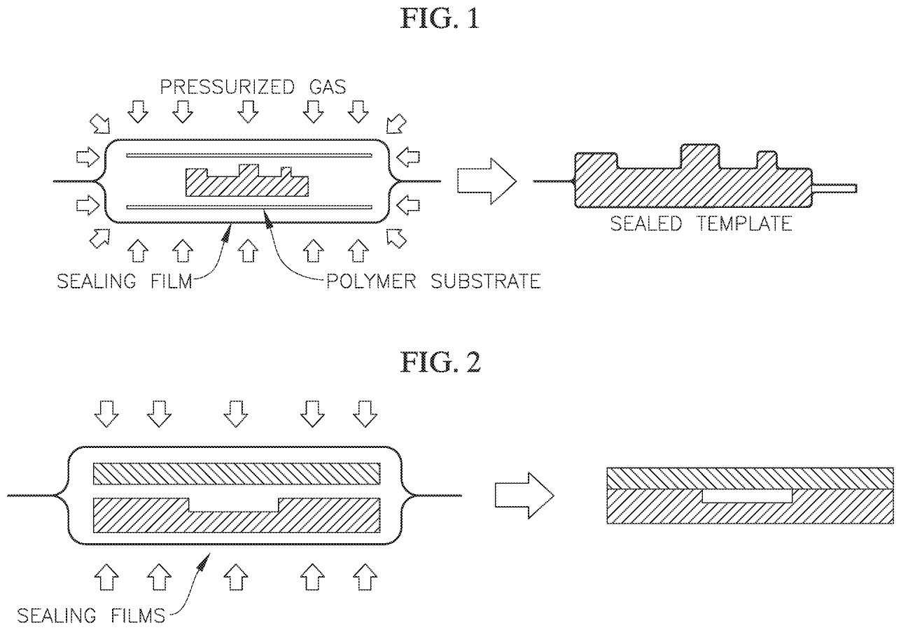

With the foregoing prefatory comments in mind, what follows is a detailed description of various exemplary embodiments. Here, a method for fabrication and assembly of inexpensive thermoplastic-based devices, such as flexible devices, is presented. The proposed fabrication methodology offers a rapid, cost-effective solution for fluid encapsulation between Nafion™ membranes (e.g., Nafion™ 212 proton-exchange membranes (PEMs), such as those available from Fuel Cells Store, USA). It should be understood that a variety of substrates can be used in practicing the present invention, polymethylmethacrylate (PMMA) being one example. The fabrication methodology of the present invention can be used separately, or coupled with other microfabrication methods to produce sealed microstructures on polymer and/or thermoplastic substrates. In this technique, an air cushioned pressure is used to laminate the substrates and produce the templated structure. FIG. 1 illustrates the process by which gas compresses a sealing film around a substrate in order to simultaneously press the substrate onto a template and seal and encapsulate the substrate inside the sealing film. This technique not only removes the need for complex molds or adhesives but also combines the structure formation step with the sealing step. Adhesives can also be applied, in order to further improve the sealing or enhance the cushioning during the bonding step.

Specifically, the combined formation and sealing steps can be performed via the technique of gas-assisted thermal bonding (GATB), which can be used to seal a porous template within thin polymer substrates to assemble microfluidic devices. In this GATB method, a gas, such as an inert gas (e.g., nitrogen), applies pressure to form a seal. In the GATB process, sealing films are usually utilized to permit the external gas pressure to compress the enclosed volume. The configuration and characteristics of the sealing films impact the functionality of the GATB process and can be varied by application. For instance, fluorosilicone rubber films can be used to this end.

FIG. 2 illustrates a template-free thermal sealing process. The uniform pressure applied in this method accommodates relative rotations, surface irregularities and thickness variations along the bonding interface to avoid deformation and thinning.

Further embodiments and details relating to the present invention and the GATB method can be found in the publication entitled “Rapid and Simple Assembly of a Thin Microfluidic Fuel Cell Stack by Gas-Assisted Thermal Bonding,” the entire contents of which are incorporated herein by reference and made a part of the present application for all purposes when and where permissible.

Among other implementations of the present invention, thin Nafion™ substrates can be used to build a two-cell air-breathing fuel cell stack. To construct a fuel cell, first, air cushioned pressure is applied to the assembled device layers by nanoimprint lithography (NIL). In this process, the temperature is raised to around 180 C to directly bond the membranes. By way of example, the template-based thermal sealing directly laminates GDEs, or other templates, within two Nafion™ 212 membranes to create a microfluidic fuel cell with the membrane itself as the packaging for the device. Such a device would be composed of two identical cells that are connected in parallel and share a hydrogen-fed microchannel on their anode side. In an embodiment, the stack is conditioned for 72 hours with humidified gas and can be characterized under different hydrogen flow rates. Maximum power densities of 120 and 140 mW/cm² were recorded for the stack and individual cell performances, respectively. In the parallel stack design, two identical cells with distinct gas diffusion layers (GDLs) are separated by a common anode plate with the flow channels on both sides. In the present design, aside from the shared fuel feeding, the anode's GDL and current collecting structures have been integrated, which makes the design more compact and flexible without any silicone, glass or other rigid substrate. Using the template-based thermal sealing method, an air-breathing micro fuel cell with direct hydrogen flow-through porous anode electrode may be realized.

In the case of fuel cells, and following the sealing step, cathode electrodes can be pressed onto the outer sides of the active area and any templates used (e.g., for inlet and/or outlet) can be removed if need be. The fluidic connections (i.e., inlet and outlet channels) to the reacting area can be sealed with or without using adhesives. In some embodiments, different patterns (e.g., rectangular, circular or diamond shapes) and dimensions of anode electrodes can be sealed between polymer electrolyte membranes to function as the anode electrode. Based on the different anode shapes, different air-breathing cathode shapes can be designed to coordinate with anode electrodes.

The fluidic channels (including inlet, anode chamber, and outlet) can be constructed during the thermal lamination (i.e., sealing) process, or first be created by techniques such as hot embossing and then sealed/capped by the thermal lamination process. The cathode electrodes can be connected to this design in the same lamination process (sealing step) or they can be added in a separate thermal compression step without damaging the anodic channel.

To collect current from the active electrode surfaces, a thin metal wire, such as silver wire, can be directly attached to gas diffusion electrodes during the same aforementioned thermal sealing step, or in a separate thermal compression step as mentioned above. When the surface area of the electrodes increases, techniques such as screen printing, doctor blading and sputtering can be used to create a thin layer of catalyst or the current collector layer on the gas diffusion layers. For the case of cathode electrodes, a conductive coating can be applied to the clamp surface to create the cathode contacts.

A micro fuel cell made in accordance with an embodiment of the present method can be an air-breathing flexible device that is constructed using Nafion™ polymer, or another ion-permeable polymer, as its membrane substrate. The microchannels are microfabricated within the membrane substrate. Thermally sealed microchannels are structured within the Nafion™ membrane, which makes it possible for the channels to deliver gas/fuel to the microchamber area and to outflow the excess reactants and/or byproducts. The present design is a micro-device that also possesses varying thicknesses at different locations. This feature is nearly impossible to achieve with conventional rigid-plate hot press machines due to an unbalanced stress distribution that would develop across the sample. A flexible micro power source made with Nafion™ polymer in accordance with an embodiment of the present invention can be made without any rigid sealant/substrate. It also makes possible considerable scaling down of fuel cell packaging in 2 and/or 3 dimensions with lightweight packaging while maintaining high power output. Device designs comprising a stack of two parallel air-breathing cells with a shared anode differ from conventional serial stacking. The gas flow fields and current collectors have been essentially incorporated into the porous electrode layer. The sealing process also bounds the microfluidic reaction chamber of the device to porous media, which brings about a “flow-through porous” design. Furthermore, the fabrication technique of the present invention can also be employed to manufacture three-dimensional microchannel structures with varying thickness on different polymer substrates. Such flexible micro fuel cells can deliver high volumetric energy density (e.g., on the order of 1200 mW/cm³) compared to their present counterparts. This metric may be further improved upon when considering gravimetric power densities.

The one-step template-based thermal sealing process combines the microchannel patterning with the sealing step and thus enables the fabrication of a symmetric fuel cell stack with improved performance based on thin uniform Nafion™ substrates. The Nafion™ polymer offers a thin, light and flexible energy source with a relatively low cost of manufacturing.

The same thermal sealing procedure can also be used directly to cap a pre-patterned polymer substrate, or it can be employed to create a sealing around a free-standing template (or an entire device). In the latter condition, the uniform lamination pressure flexes both substrates coordinately around the embedded element to form the sealing at once; thus, a symmetrical sealing can be achieved when the enclosed element is also symmetrical in shape. Also, thin substrates can be employed to seal high aspect ratio structures without any complex mold being involved. In this condition, the sealed template can be solid or porous. A sealed porous template can function as a flow path by lateral transfer of fluid within the pores.

Through thermal sealing and simultaneous microstructuring of polymer substrates, a single hermetic device can be formed by sandwiching a template between the substrates during the application of heat and pressure. The sealed template ideally should be strong enough to replicate its shape in the molded substrates, but it can be either solid or porous. The procedure can be employed as a process for simple bonding of a capping layer on a pre-patterned polymer substrate, or as a method to form patterns in the substrates; however, its great advantage lies in the ability to simultaneously form and seal microfluidic environments within pristine polymer substrates in a single step. When creating void or empty structures or microchannels, the template needs to be removed after the sealing step; use of a porous template eliminates the necessity of removal. Template removal can be carried out by applying a mechanical force or dissolving in a solvent.

Fuel cells made in accordance with embodiments of the present invention can function in either open-ended or close-ended configurations; in the close-ended operation, the outlet channel can be closed during the operation and opened periodically to avoid flooding or unwanted gas accumulation. In an embodiment, a clamping force can be applied to the different sides of the reacting area, with various possible geometries, to reduce contact resistances and to collect currents from cathode surfaces. The clamping force can be applied through lightweight polymer structures that do not block air flow to the cathode surfaces.

Such thin flexible fuel cells are designed to be conformable to the different geometries of the clamping force applied to the reacting area. Therefore, the fuel cell can be straight, curved or bent to adapt to different geometries depending on the clamps.

In this design, either one or both substrates can be ion-exchange membranes; therefore, the fuel cell can include one air-breathing cathode, or two air breathing cathodes positioned on different sides of the anode. In the case of single-sided fuel cells, the non-active polymer substrate opposite the single cathode can be a thermoplastic polymer that binds to the ion-exchange membrane, with or without adhesives, to be used as a supporting substrate. In both fuel cell designs, the ion-exchange membranes have the dual function of ion transport properties as well as operating as the fluidic substrate/packaging material. To this end, catalyst-coated membranes (CCM) can also be used.

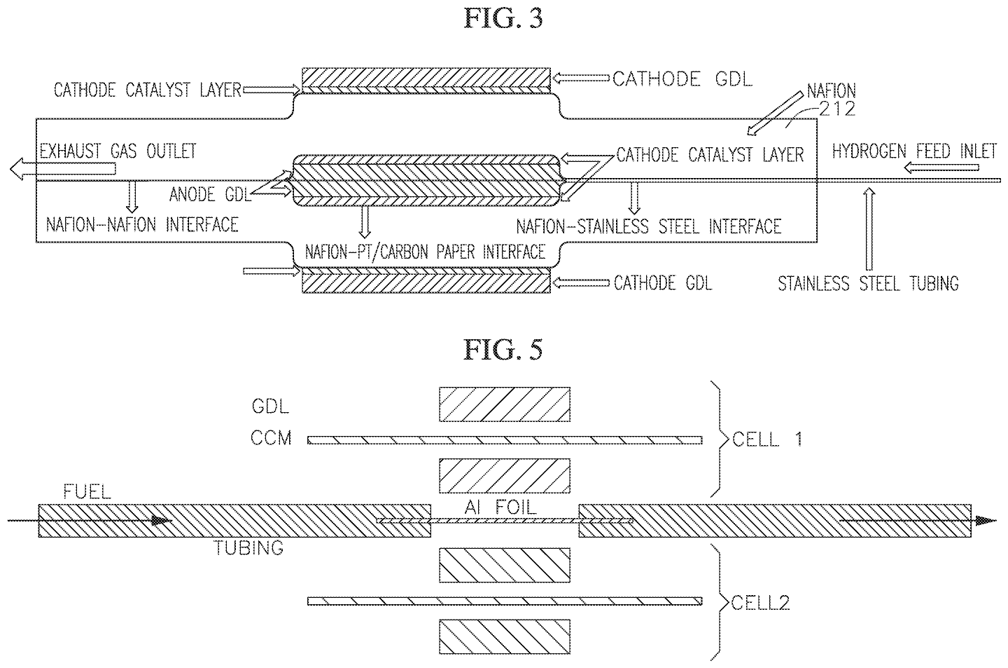

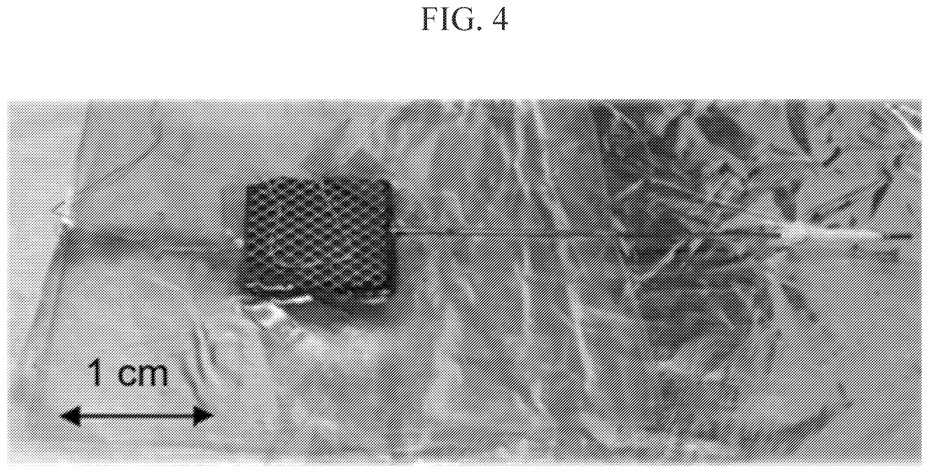

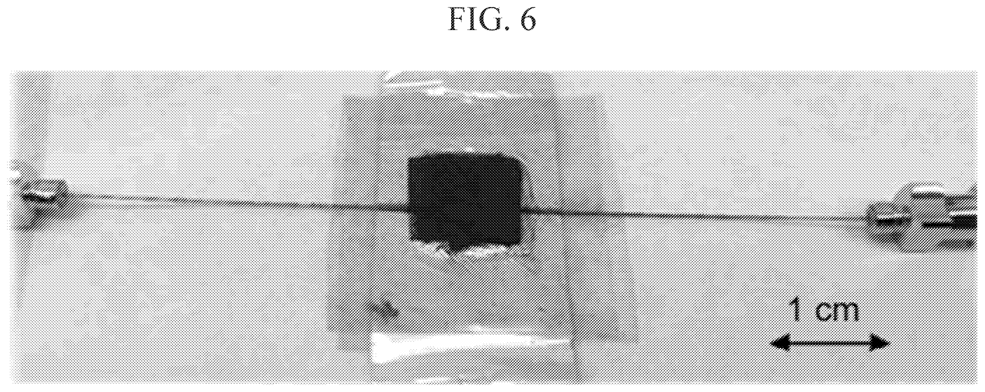

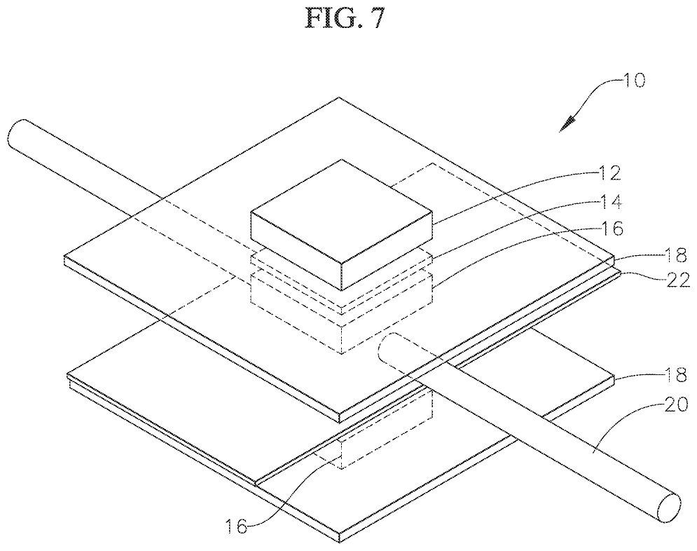

FIG. 3 shows a schematic diagram of a conventional TFFC construction, whereas FIG. 4 is a photographic example. In contrast, in one embodiment, the present invention involves sandwiching a layer of aluminum or other metallic (such as nickel, titanium, chromium, etc.) foil between two Nafion™ or other substrate layers. With the provision of the metallic layer, the bonding of the substrates can be significantly improved using relatively low fabrication temperature. In contrast, a photograph of a fuel cell made in conjunction with the present invention appears in FIG. 6. FIG. 5 is a schematic of an exploded view of FIG. 6, while FIG. 7 is a schematic rendition of a fuel cell 10. In general, the inventive new method increases the bonding strength, and in this case, the strength of the hermetic perimeter sealing of the TFFC anode chamber. In one configuration, a perfluorosulfonic acid polymeric proton exchange membrane 18 (such as Nafion™) is interposed between a stack having a cathode gas diffusion layer 12, a cathode catalyst layer 14 and an anode gas diffusion layer 16, and an aluminum layer 22. A second perfluorosulfonic acid membrane 18 is interposed between aluminum layer 22 and a second stack, which can have layers corresponding to layers 12, 14, 16 (see FIG. 7). Perforations in the aluminum layer 22 allow free transport of incoming hydrogen gas laterally entering the anode region via the tube 20, permitting distribution of the hydrogen throughout the anode gas diffusion layers.

Well-bonded structural layers are required for a robust TFFC to be able to generate sufficient power for a drone or other device. TFFCs are advantageous for such applications as they are small devices (e.g., 1 by 1 square centimeter), and they are portable and flexible and can provide extremely high power densities (>1.5 W/g). To ensure the TFFC is able to achieve these parameters, the sealing and the bonding of its structural materials are fundamental aspects that should be attained.

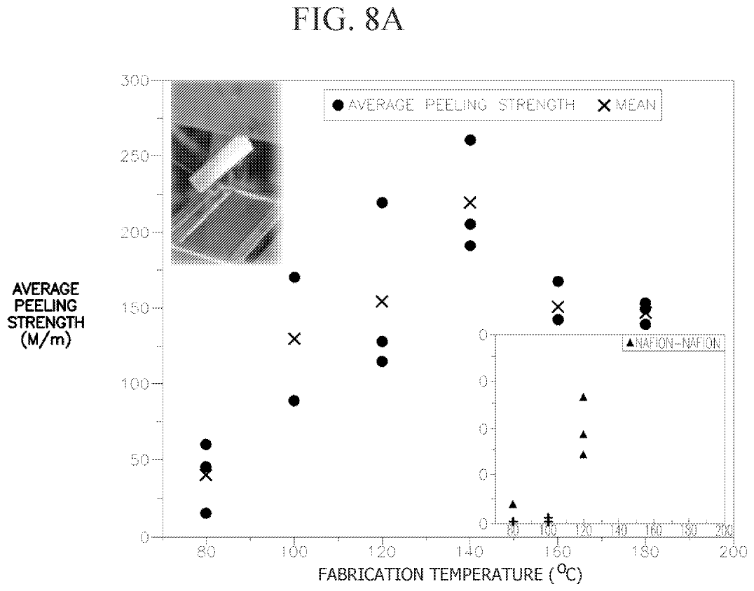

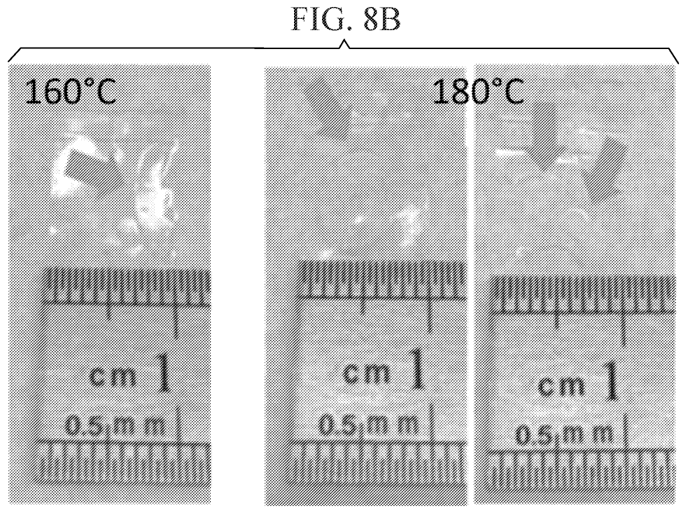

Overall, an embodiment of the present invention involves sandwiching aluminum foil in between the two Nafion™ layers, and then briefly applying heat and pressure. This differs from conventional methods of forming a hermetic seal at the perimeter of Nafion™, which rely on continuous mechanical compression or applied adhesives and/or sealants. By applying the inventive methodology, the bonding strength of the layers is increased. As experimental verification, a layer of aluminum was sandwiched between two Nafion™ laminae and then characterized by T-peel testing, which can obtain the bonding strength of two bonded membranes. Samples were fabricated under various temperatures, pressures and time. In the T-peel test, a pulling force is directed perpendicular to the overlap joint of the samples; this separation of layers mimics the forces in the device in use to help assess the possibility of delamination caused by the pressure of the fuel (e.g., hydrogen). FIG. 8A demonstrates that by adding a layer of aluminum foil between two Nafion™ layers, the bonding strength increases at least 10 times. FIG. 8B is a series of photographs illustrating a bubble-like structure that emerged with processing temperatures between 160° C. and 180° C.

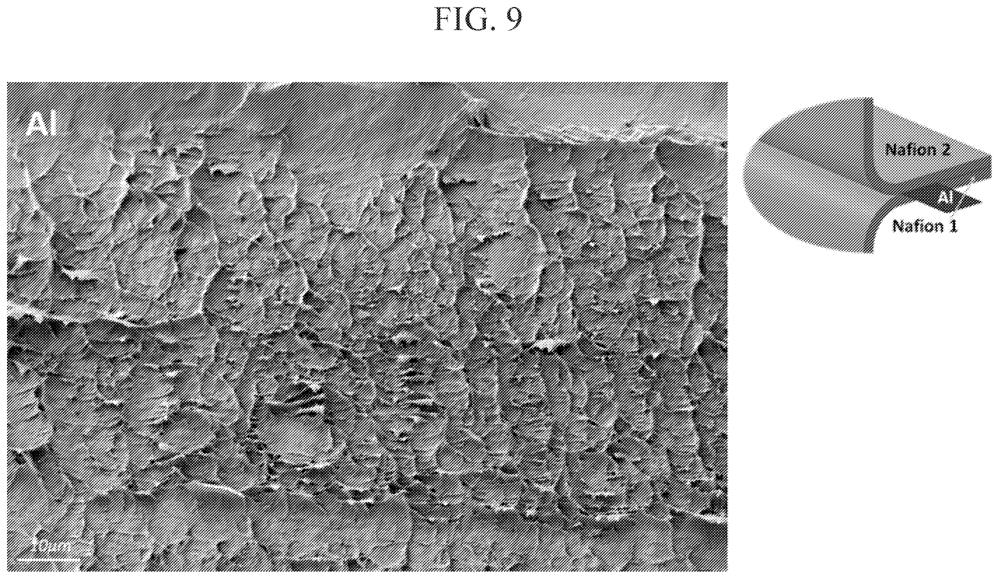

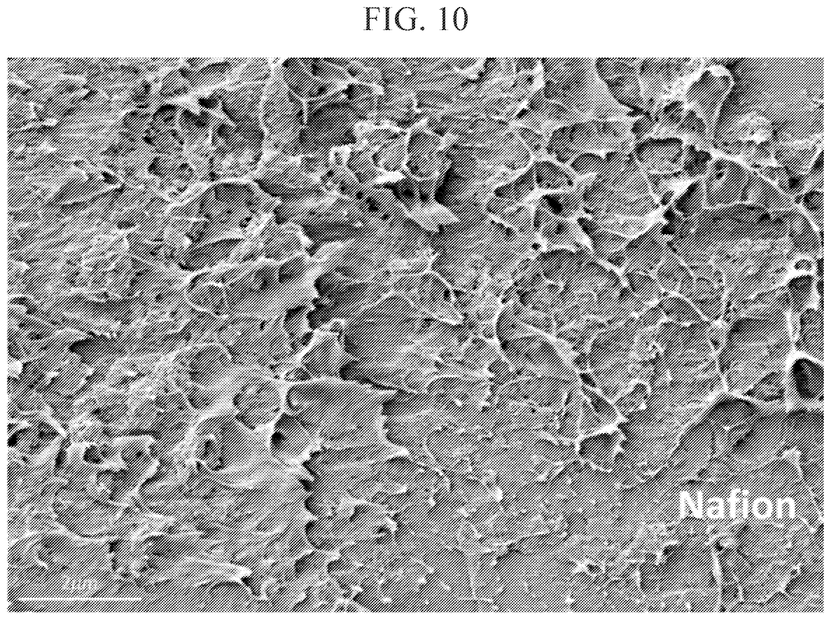

After the T-peel test, the surface morphology was characterized by scanning electron microscopy (SEM). FIGS. 9 and 10, respectively, show Nafion™ membranes directly bonded together and Nafion™ membranes bonded with aluminum interposed between. The microstructures showed surface changes that are nearly imperceptible to the naked eye. Raised areas on the surface indicated that one of the Nafion™ layers remained firmly bonded.

### Example 1

For GATB processing, a nanoimprint lithography (NIL) system (Nanonex, NX-1000) originally dedicated to thermal NIL was used. Details about the GATB approach and apparatus have been described in Mahmoodi, SR. Gas-assisted thermal bonding of thermoplastics for the fabrication of microfluidic devices. Microsyst Technol 2019;9. https://doi.org/10.1007/s00542-019-04380-9. In the Nanonex NIL setup, the specimen is sandwiched between two fluorosilicone rubber films to permit the pressurized gas to compress the enclosed volume while the temperature is raised by IR-lamp radiation. Before starting the process, the substrate and the template are put into contact under vacuum. Then, the temperature and the pressure are increased, with similar profiles as hot embossing processes but at a relatively higher temperature. For a 2-minute bonding, the entire GATB process including RT-vacuum, heating, bonding and cooling steps takes normally less than 7 min. Using NX-1000, it is also feasible to perform GATB in a batch of two or three depending on the polymer sample dimensions.

An initial microfluidic prototype was built by one-step sealing of a porous template between two PMMA films. The porous template remains between the PMMA substrates to create a porous microchannel by permitting fluid transfer laterally through the pores. Therefore, plain carbon cloth with a nominal thickness of 356 μm was cut into custom patterns and used as a porous template. Polytetrafluoroethylene (PTFE) microtubing (PFA series, IDEX LLC) and small cuts of 200-μm-diameter copper wire were used as templates for creating the inlet and outlet channels, respectively. To avoid leaks at the inlet channel, adhesive was applied around the PTFE tubing before GATB to fill the gaps between the impinging surfaces during the thermal sealing step. Copper wire (D=200 μm) was also threaded into the inlet PTFE tube (ID≈220 μm) as a support to ensure that the tube does not deform under GATB conditions. After GATB pressing, the outlet channel was created by carefully drawing out the template copper wires. Small pieces of Kapton tape were used to secure the templates in their positions between the two PMMA substrates prior to GATB to ensure fluidic connections. Cross-sectional cuts of the microfluidic prototype were verified by SEM imaging.

Fabrication of the MFC began by the preparation of catalyst coated GDEs. 20 wt % Pt and 40 wt % Pt on carbon catalysts (Fuel Cells Etc., FuelCellsEtc.com) were used to prepare anode and cathode electrodes, respectively. Two slurries containing the catalyst, deionized water, ionomer (D10215 wt % Nafion solution, Fuel Cells Store) and isopropyl alcohol (≥99.5% Alfa Aesar) were prepared based on a previous procedure described in DeBonis D, Mayer M, Omosebi A, Besser R S. Analysis of mechanism of Nafion conductivity change due to hot pressing treatment. Renew Energy 2016;89:200-6. https://doi.org/10.1016/j.renene.2015.11.081. The carbon to ionomer weight ratio was 1.2. The IPA to water weight ratio was kept at 0.24 to tune the viscosity of the suspensions for the coating step. For the two pairs of anode and cathode gas diffusion layers (GDLs), AvCarb P50 carbon paper (Fuel Cells Store) was cut into 5×5 mm² and 10×10 mm² square pieces to prepare MFCs in two different dimensions. The slurries were coated by shearing a doctor blade, followed by drying at ambient conditions to form the GDEs. A plastic frame was designed and built by 3D printing to mount the carbon paper pieces within the plastic frame with customized depths which allowed accurate control of the doctor blading process and, therefore, the catalyst loadings. After drying, the catalyst loadings of the anode and cathode GDEs were measured to be around 0.2 mg Pt cm-2 and 0.5 mg Pt cm-2, respectively. In a similar procedure, a thin layer of silver paste was applied to the uncoated side of one of the anode GDEs to function as the current collector. Thereafter, a 50-μm silver wire (A-M Systems Inc.) was embedded onto the silver coated surface as the anode electrical contact. The two anode GDEs were then held together while the silver paste dried in ambient air to secure the anode contact between the GDEs.

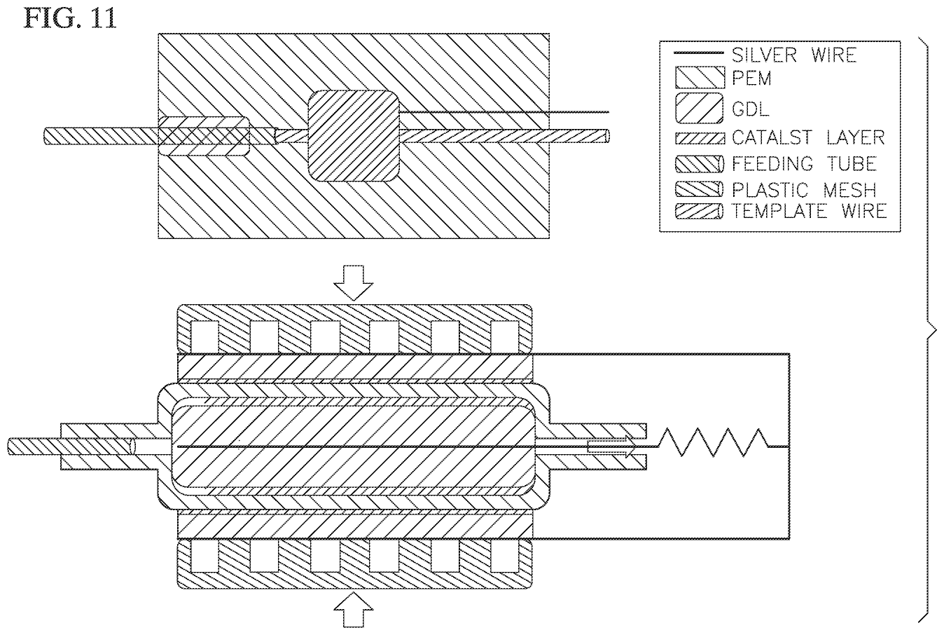

Template based GATB was employed for simple and rapid fabrication of an air-breathing FC stack to build a FC stack with thin PEMs as the substrates. As a result, the prepared assembly of the anode electrodes was sandwiched as the porous template between two Nafion 212 PEMs (Fuel Cells Store). A stainless-steel hypodermic needle (26-gauge, 50 mm long, 4.57 mm OD, 0.25 mm ID, Component Supply) was used as the inlet to feed fuel to the device. A 200-μm diameter copper wire was threaded through the hypodermic needle to function as the fluidic template in the spacing between the anode chamber and the needle. The spacing was created to avoid damaging the device when clamping force is applied for FC characterization. Similarly, the outlet channel was made by securing a small piece of 200-μm copper wire connecting the anode chamber out of the Nafion substrate. To seal the inlet end, drops of epoxy glue were applied around the needle before GATB. The fluidic elements were secured in their respective positions by small pieces of Kapton tape. After securing the elements, a Nafion 212 sheet was placed over the entire device. Prior to the GATB step, cathode GDEs were placed on the outer sides of both membranes and were secured by small pieces of Kapton tape. The entire assembly was then enveloped between the sealing films of the Nanonex machine and pressed. The GATB processing was performed at 220° C. and 230 psi for 2 min. As mentioned earlier, GATB was performed using the NIL system to provide a uniform gas-cushion pressure over the bonding components with non-uniform thickness. The top-view of the MFC assembly prepared for the GATB process is shown schematically in FIG. 11A.

After the GATB step, the copper wire templates were gently drawn out to produce the anode fluidic connections. The FC components generally need to be held together with enough compression to minimize contact resistances. Therefore, a clamping force was applied on the reacting area to reduce the contact resistances during electrochemical testing. This clamping force was applied through a simple plastic clamp containing jaws with small openings to allow ambient air to reach both cathodes and to tightly hold the silver wire contacts on the cathode electrodes. The clamping force on the device was measured with a load cell to be around 1 kgf cm⁻² (14.2 psi). This clamping force was kept constant for all electrochemical tests. The hypodermic needle was connected to the gas feeding system by stainless steel Luer fittings. A schematic of the MFC test setup is illustrated in FIG. 11B.

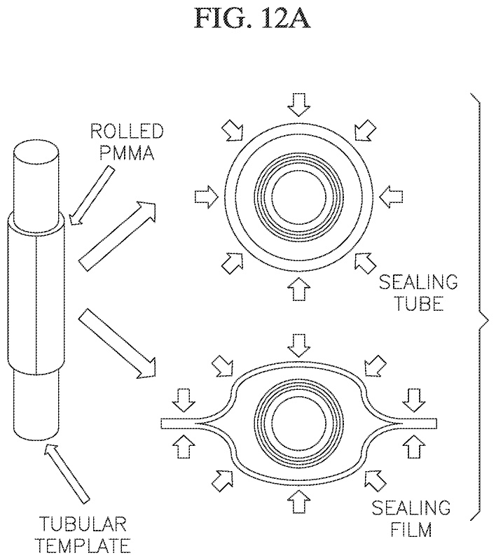

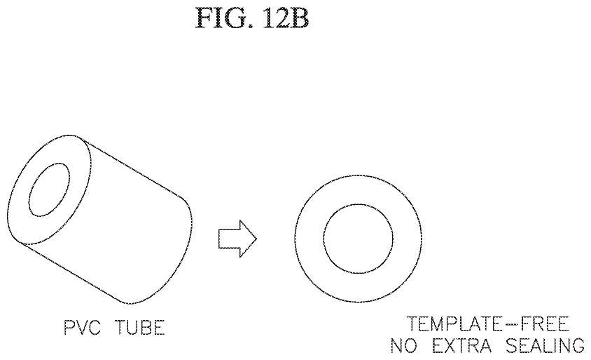

In the GATB process, sealing films are utilized to permit the external gas pressure to compress the enclosed volume. Therefore, the configuration and characteristics of the sealing films are critical to the functionality of the GATB process. Sealing configuration will determine the GATB resolution by influencing the pressure that is transferred from the pressurized gas to the bonding components. The impact of sealing configuration on GATB processing is displayed in FIG. 12A, where a PMMA film is first rolled around a solid tubular template, and then pressed by GATB through two different sealing configurations: (1) a cylindrical rubber tube and (2) the standard overlaying rubber films. In the third sealing configuration (FIG. 12B), a capped hollow tube is compressed without any template, which did not require further sealing. After the GATB pressing, the solid template was demolded, and the cross-sectional cuts of the different samples were characterized by SEM. It was found that the applied pressure can solidify the rolled PMMA layers together to form a solid tube. When using standard NIL rubber sealings, the parallel sealing films prevent a uniform radial stress transfer to the PMMA layers and consequently, an eye-like cross-section forms. For the hollow PVC tube, the sealed environment is created by the hollow geometry of the tube itself, which allows the isostatic pressure to press the sample without any further sealing. Therefore, the uniform radial pressure from GATB compresses the hollow cylinder, resulting in a solid circular cross section. FIGS. 12 and 12B highlight the elimination of a rigid press in GATB for the assembly of non-flat and 3D structures, which becomes challenging when using uniaxial compression. Aside from the effect of sealing films, the GATB parameters such as temperature, pressure, and time influence the resulting GATB structure.

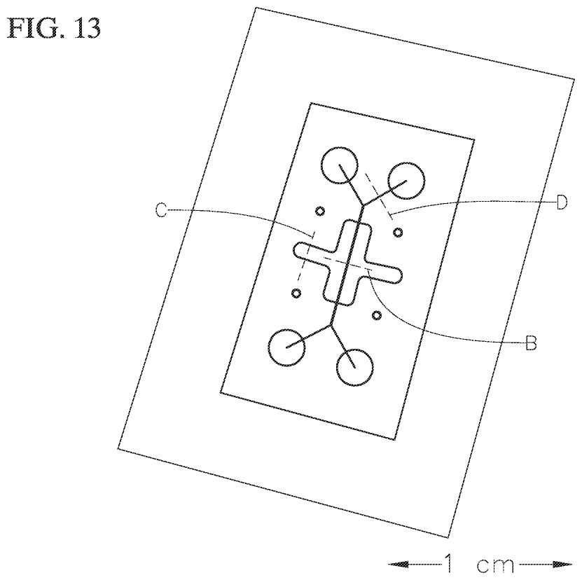

GATB assembly on a Si-based template was also investigated to study the thermoforming process in this technique. The patterned Si-based template can be prepared using photolithography. FIG. 13 shows a patterned SU-8 resist on a Si substrate that has been sealed between two PMMA films by GATB at 170° C. and 250 psi without any anti-stick coating. The hard-baked SU-8 resist functions as a rigid template against the PMMA film as it possesses outstanding stiffness, even under high temperatures.

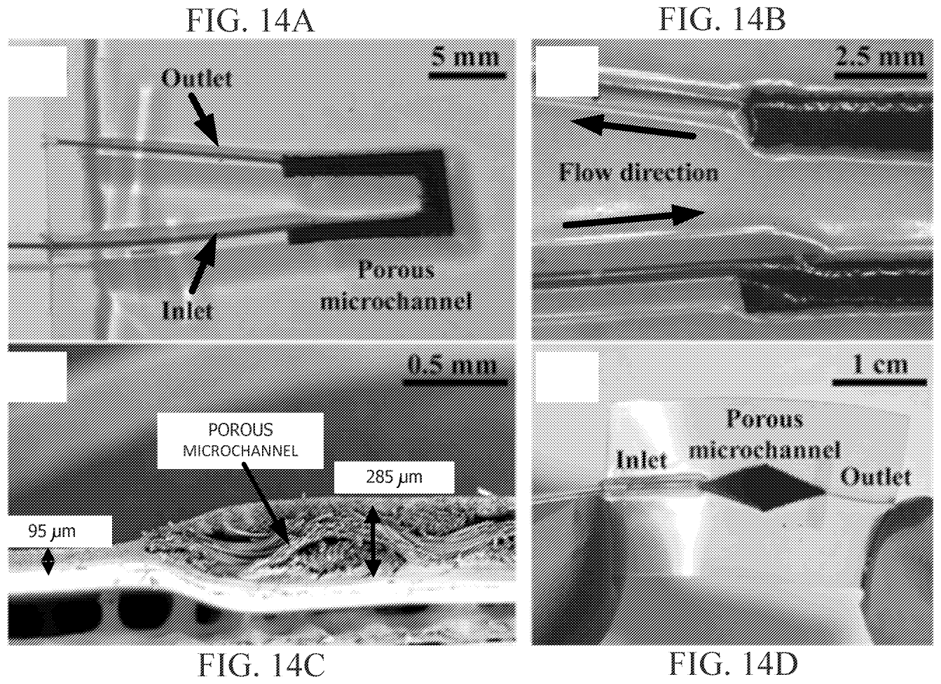

FIGS. 14A and 14B show a camera image and stereo-optical image, respectively, of a microfluidic prototype assembled by template based GATB using thin PMMA substrates. In the prototype, small pieces of porous carbon material function as a scaffold during the thermal bonding step that leads to formation of a fluidic channel. A SEM cross-section of the sealed porous microchannel is shown in FIG. 14C. The image shows the sealed porous microchannel height to be around 285 μm, in contrast to the PMMA films (˜95 um). The PMMA substrate thinning was measured to be on the order of a few micrometers and was uniform over the entire cross-section. Carbon materials such as carbon cloth were used (FIGS. 14A-14B) and carbon paper (FIG. 14C) was used as the scaffold to demonstrate the versatility of GATB prototyping. This prototype validates that a porous template can permit the transfer of a fluid through porous strips, opening up a pathway for novel microfluidic device fabrication based on thin thermoplastic films. Furthermore, the fact that GATB enables the ability to create a packaging based on custom, thin polymer films without applying sealants or anti-stick layers is important to build devices with dual functioning packaging. In the next section, the template based GATB method has been adopted to build an MFC stack with a thickness of less than 1 mm based on PEMs.

### Example 2

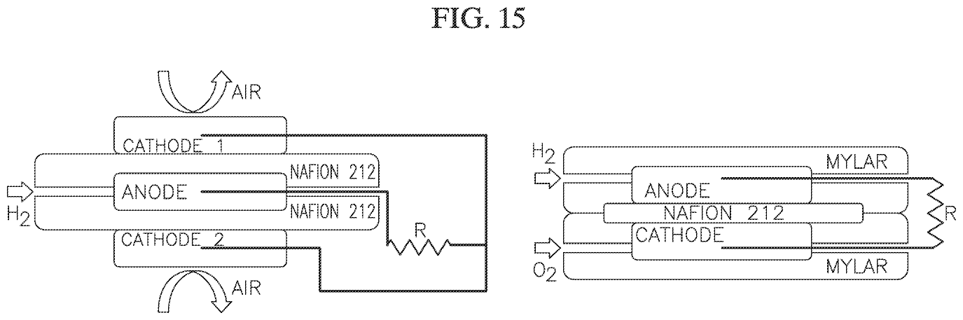

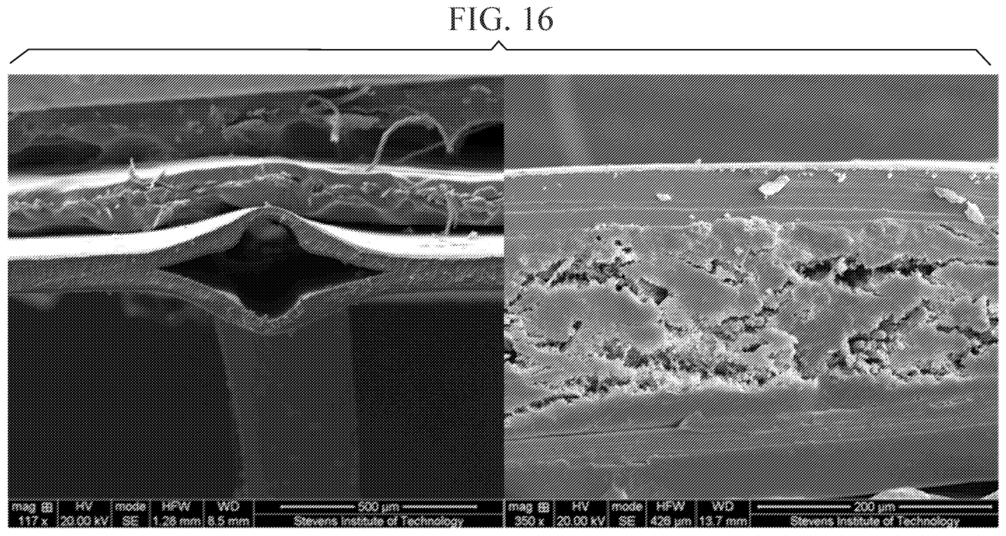

A μFC prototype was designed to study thin and flexible microfluidic fuel cells. Two Nafion membranes were used simultaneously both as the sealing/packaging base material and, also as the interactive electrolyte layer. The μFC device assembly is shown in FIG. 15. As illustrated in FIG. 15A, the porous anode chamber is enveloped by GATB by the two Nafion membranes. This microfluidic architecture bounds the hydrogen flow to the GDL's cross-section area without any conventional flow channels involved. In this design the fuel is fed directly through the porous microchannel in an in-plane direction. Hydrogen can spread over the catalyst regions at the opposite vertical ends of the microchamber frame by a through-plane diffusion. In FIG. 15B, a thermoplastic substrate, such as Mylar, can be used to construct a microfluidic fuel cell.

A cross-section SEM image of the inlet microchannel and the anode microchamber area after performance testing is shown in FIGS. 16A and 16B, respectively. SEM images demonstrate that GATB can securely attach the two Nafion membranes together without leaving any apparent gap at the contacting interface. The inlet opening is formed by de-molding a 200-μm-diameter template wire between the two Nafion substrates. Image analysis on the inlet cross-section shows that the generated opening is approximately identical to a circular cross-section area of a 300-μm-diameter micropipe, which can increase under pressurized conditions due to the flexibility of the microchannel walls. FIG. 16B illustrates the porous anode microchamber sandwiched between the Nafion membranes and the outer cathode electrodes. The entire porous microchannel height is measured to be about 180 μm. The final hot-pressing step allows for a secure connection between the silver wire current collectors on the cathode GDLs.

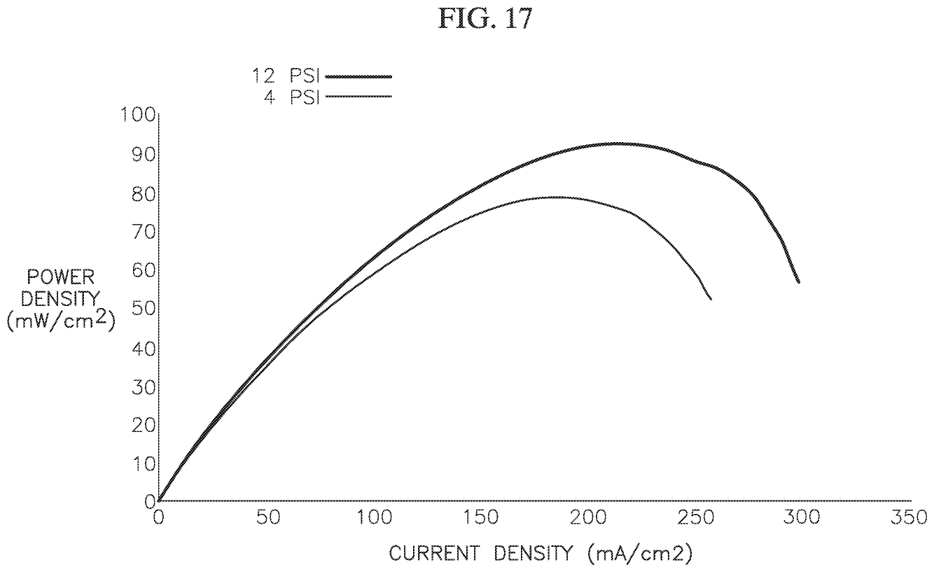

The hydrogen pressure effect on the fuel cell performance was studied (see FIG. 17) in dead-ended operation of the device, as the dead-ended mode enables the manipulation of the pressure inside the device. By increasing the pressure from 4 psi to 12 psi in dead-ended operation, a rise in the performance can be observed. A peak power density of 96 mWcm⁻² at 12 psi is achieved at room temperature by blocking the outlet microchannel. The dead-ended operation of the device suggests that fuel pressure in the porous microchamber cannot be improved effectively, probably due to the flexible nature of the device and also the presence of low-resistance diffusive paths of flow. Pressure loss is one of the parameters that regulates total system efficiency and optimization, and it becomes more vital in micro fuel cell systems. Furthermore, in fuel cells, increasing pressure accelerates the electrochemical reaction through enhanced hydrogen transport to the GDL and further to the catalyst region.

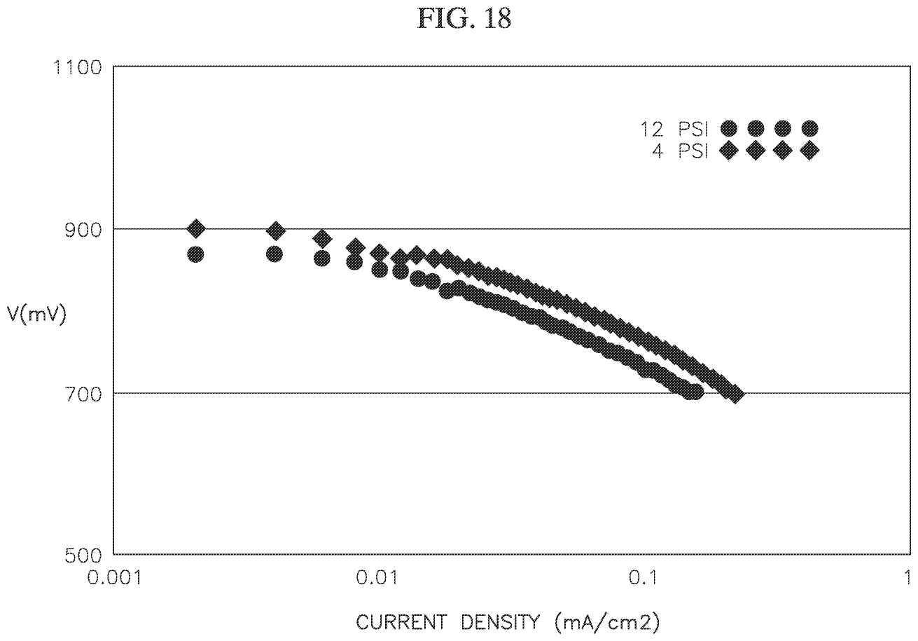

In order to further assess the contributions of reaction kinetics and mass transport to polarization losses, a Tafel analysis is performed on the V-I data. The extracted Tafel slopes (FIG. 18) were about 80 mV/dec for both pressure conditions. The Tafel slope is an indication of polarization required to overcome the kinetic resistance and higher Tafel slopes result in lower performance.

It is noted that the output characterization curves are collected from both cathodes with a common anode electric outlet. Therefore, the device's output performance can be regarded as a stacking of two parallel cells with a shared anode. Fuel cells are usually electrically connected in series to create a fuel cell stack with a higher voltage. However, any large area fuel cell can be represented by a set of smaller cells in parallel. For fuel cell characterization, it is known that the cell potential at a given operating point is affected by activation, kinetic, and ohmic loss mechanisms. It is possible to better visualize the kinetic and mass transfer losses independent of the ohmic losses by plotting the IR-compensated potential as a function of current density. The IR-compensated potential is the measured potential plus the voltage drop due ohmic resistance. The slope of the IR-compensated polarization voltage as a function of current density is proportional to the low frequency intercept of the modified impedance spectra and represents the sum of the equivalent kinetic and mass transfer resistances.

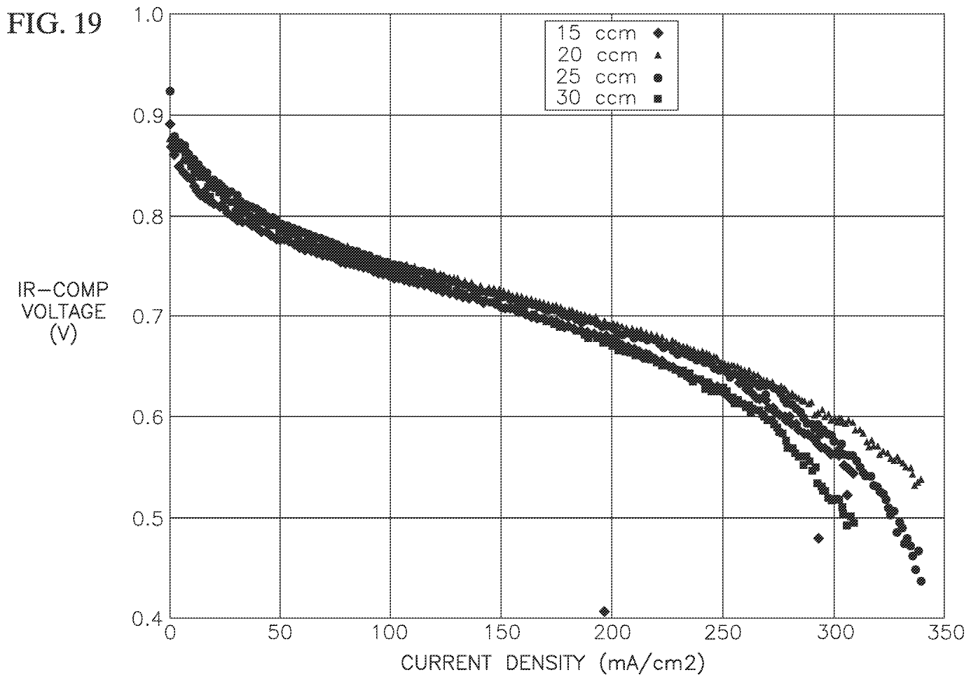

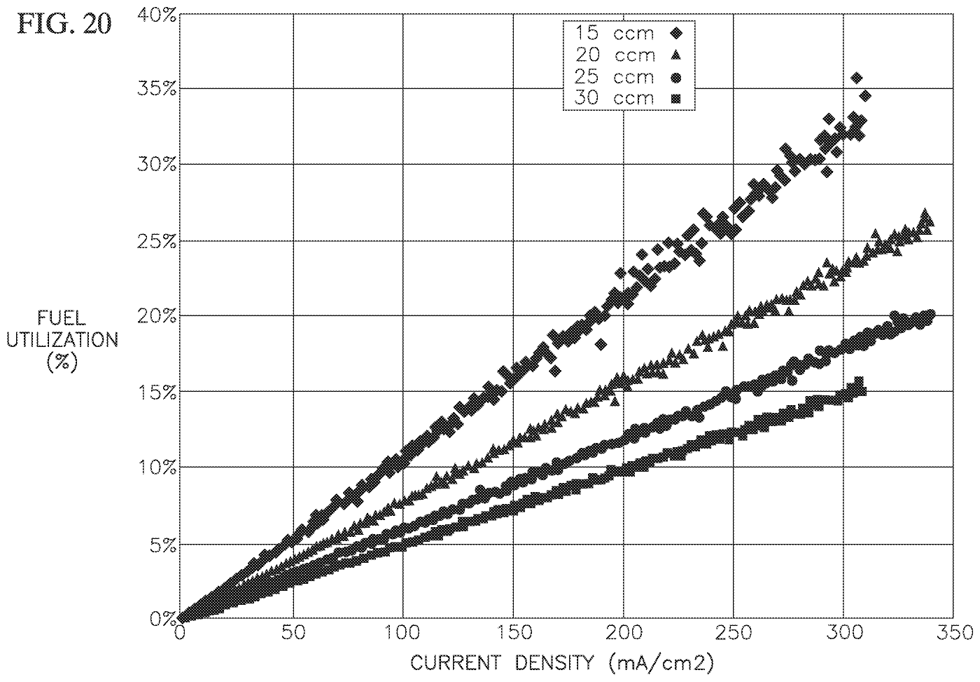

The IR-free performance results of the μFC at different flow rate is illustrated in FIG. 19. It can be seen that the 20 ccm flow curve shows a delayed mass transport drop compared to the other flow rates. Also, the trend in different flow rates is identical in lower current densities. At higher current densities, due to populated reactions, the curves become more divided, and the 30 sccm curve demonstrates the highest mass transport loss, which can be explained by non-uniform distribution of the fuel at different flow rates. Fuel utilization plots at different flow rates are shown in FIG. 20. Based on the presented data, the highest utilization happens at 15 ccm, and it can reach a maximum of about 35% at 300 mAcm⁻². The inlet flow in this graph is achieved from the instant recordings of mass flow controllers.

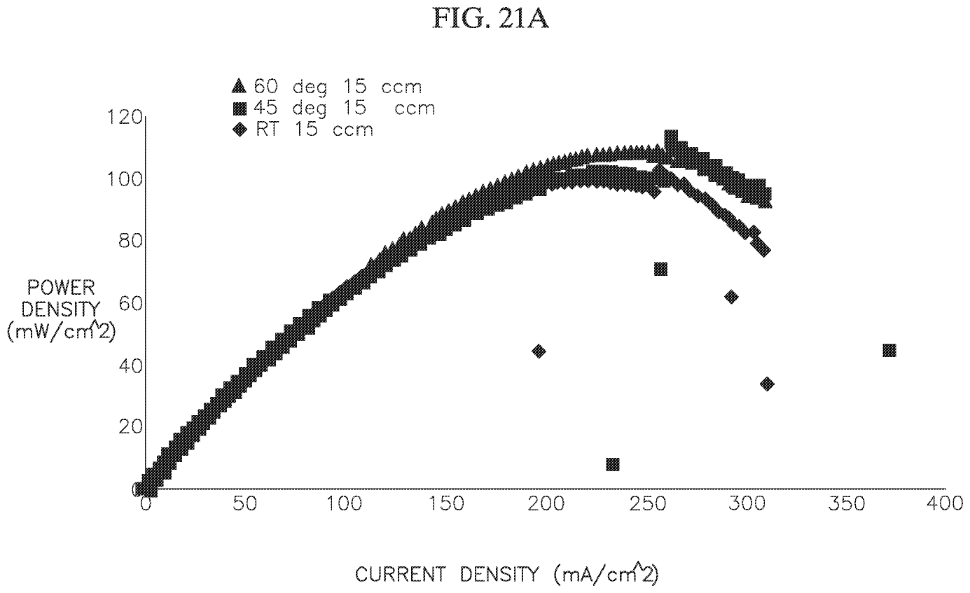

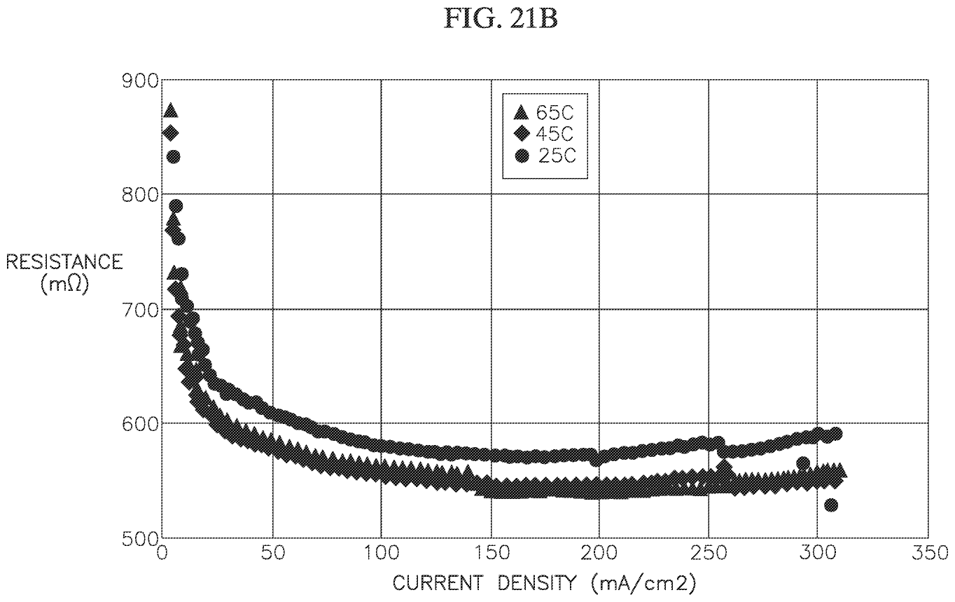

The effect of Hydrogen pre-heating on the stack performance at 15 ccm is illustrated in FIG. 21A. The fuel pre-heating impacts the membrane conductivity. FIG. 21B shows the ohmic resistance as a function of current density for three pre-heating temperatures. At this range of temperature, the membrane can be well hydrated with product water, and the membrane resistance is approximately only a function of the temperature. Therefore, even small enhancements in the cell temperature because of the pre-heated gas can reduce the membrane resistance. According to the presented results in FIG. 21B by the current interrupt method, the resistance reduces clearly from 25° C. to 45° C. and it remains almost unchanging between 45° C. and 65° C.

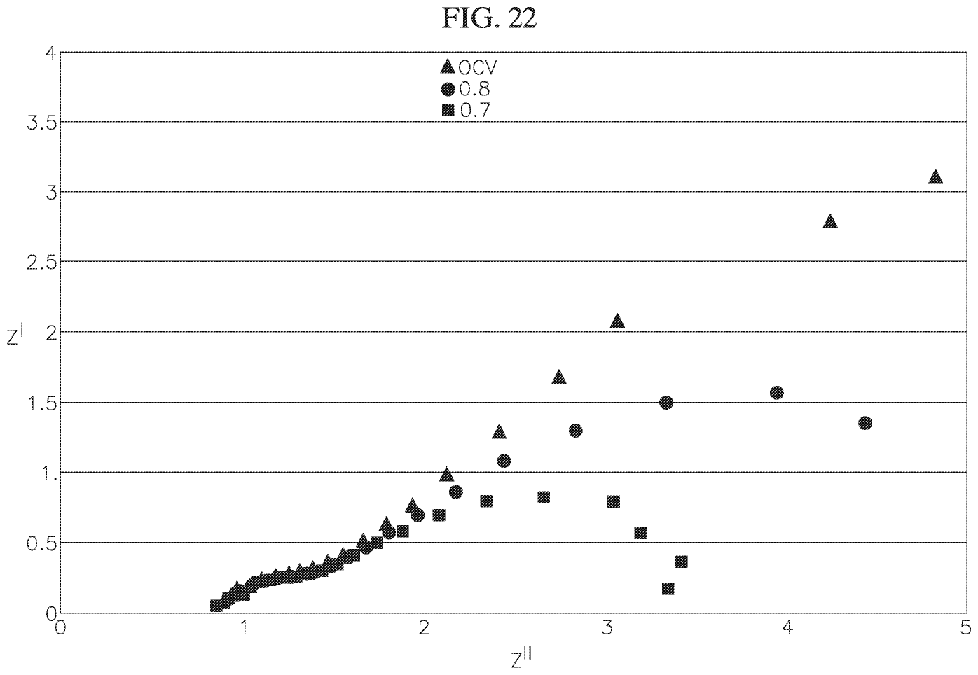

The dynamic EIS results from the μFC are shown in FIG. 22. It can be seen that by applying an external potential, the polarization radius starts to decrease. The potential-dependent arc is related to the double-layer capacitance of the electrode, combined with the charge-transfer resistance of the Oxygen Reduction Reaction (ORR). The dependency of this arc radius on electrode potential can be described by the Tafel equation: V˜logR_{ct}−1. Therefore, increasing the applied potential reduces dynamic charge transfer resistances. This reduction in resistance can affect both anode and cathode reactions. However, the ORR is the rate limiting half-reaction and controls most of the losses in the fuel cell. The increase in the ORR rate occurs by the increase in the applied potential.

It will be understood that the embodiments described hereinabove are merely exemplary and that a person skilled in the art may make many variations and modifications without departing from the spirit and scope of the present invention. All such variations and modifications are intended to be included within the scope of the invention.

What is claimed is:

1. A method for making microfluidic devices, comprising the steps of:
pressing one or more substrates onto any one of a variety of templates of arbitrary shape; and
laminating said one or more substrates simultaneously with said pressing step.

2. The method of claim 1, wherein said one template forms a bonding interface for said one or more substrates.

3. The method of claim 1, wherein said laminating step and said pressing step are accomplished via gas-assisted thermal bonding.

4. The method of claim 1, wherein said one template comprises one or more gas diffusion electrodes.

5. The method of claim 1, wherein said one template is porous.

6. The method of claim 1, further comprising the step of removing said one template after said laminating step.

7. The method of claim 6, wherein said removing step is performed via dissolution of said one template.

8. The method of claim 6, wherein said removing step is performed via mechanical force applied to said one template.

9. The method of claim 1, wherein said pressing and said laminating steps are performed using air cushioned pressure.

10. The method of claim 9, wherein said pressing and said laminating steps are performed using nanoimprint lithography.

11. The method of claim 9, wherein an inert gas provides said air cushioned pressure.

12. The method of claim 9, wherein said laminating step is performed using a rigid plate to provide laminating pressure.

13. The method of claim 1, wherein said one or more substrates comprise a thermoplastic substrate.

14. The method of claim 1, wherein said one or more substrates comprise one or more sulfonated tetrafluoroethylene polymers.

15. The method of claim 1, further comprising the step of applying cathode electrode patterns to said one or more substrates.

16. The method of claim 1, wherein said one or more substrates comprises polymethylmethacrylate.

17. The method of claim 1, wherein said laminating step is performed with a fluorosilicone rubber film.

18. The method of claim 1, wherein said one template includes a pair of opposed sides and said pressing step applies said one or more substrates to both sides of said pair of opposed sides of said one template.

19. The method of claim 18, wherein said pair of opposed sides are symmetrical.

20. The method of claim 18, wherein said pair of opposed sides are asymmetrical.

21. The method of claim 1, further comprising the step of interposing an adhesion-promoting metallic layer between said one or more substrates and said one template.

22. The method of claim 21, wherein said adhesion-promoting metallic layer is an aluminum layer.
